(19) United States
(12) Patent Application Publication
(10) Pub. No.: US 2002/0026317 A1
(43) Pub. Date: Feb. 28, 2002

(54) Process and spoken announcement module for outputting a spoken announcement and a program module therefor

(75) Inventors: Benoit Labrique, Korntal (DE); Richard Moss, Coogee (AU)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/880,753

(22) Filed: Jun. 15, 2001

(30) Foreign Application Priority Data
Jun. 17, 2000 (DE) 100 29 904.0

(51) Int. Cl. G10L 13/00

(52) U.S. Cl. 704/258

(57) ABSTRACT

The invention relates to a process for outputting a spoken announcement, the content of which is a function of the data content of at least one data record, wherein an announcement type is selected by means of a first program segment on the basis of the data content, a second program segment for the program-controlled output is made available, which second program segment is suitable for the selected announcement type, the parameters required for the second program segment which has been made available are determined, and the spoken announcement corresponding to the selected announcement type taking into account the determined parameters is output. The invention further relates to a spoken announcement module and a program module therefor.

The invention relates to a process for outputting a spoken announcement according to the preamble of claim 1, a spoken announcement module according to the preamble of claim 2 and a program module according to the preamble of claim 3.

Known spoken announcement modules are designed to output announcements having a simple structure. These mainly consist of a, possibly divided, fixed part and a variable art. Examples are time announcements (“It is now”, “five” “thirty two”), also as part of a timetable information service, the announcement of a changed telephone number, or the announcement of the costs of a long-distance call which has just ended.

In the known spoken announcement modules, announcements having a more complicated structure, for example comprising alternatives, are not possible in automatable manner.

The object of the invention is also to facilitate announcements of a more complicated structure, for example comprising alternatives, in automatable manner.

This object is achieved in accordance with the invention by a process according to the theory of claim 1, a spoken announcement module according to the theory of claim 2 and a program module according to the theory of claim 3.

Fundamentally the invention is based on the principle of providing a programming language for the programming of announcements and then using this to control the spoken announcement.

Further developments of the invention are disclosed in the sub-claims and the following description.

The proposed invention also has the advantage that the program segments not only can be used for controlling announcements but also directly facilitate the documentation of a spoken announcement module.

In the following the invention will be further explained with reference to the attached drawings in which:

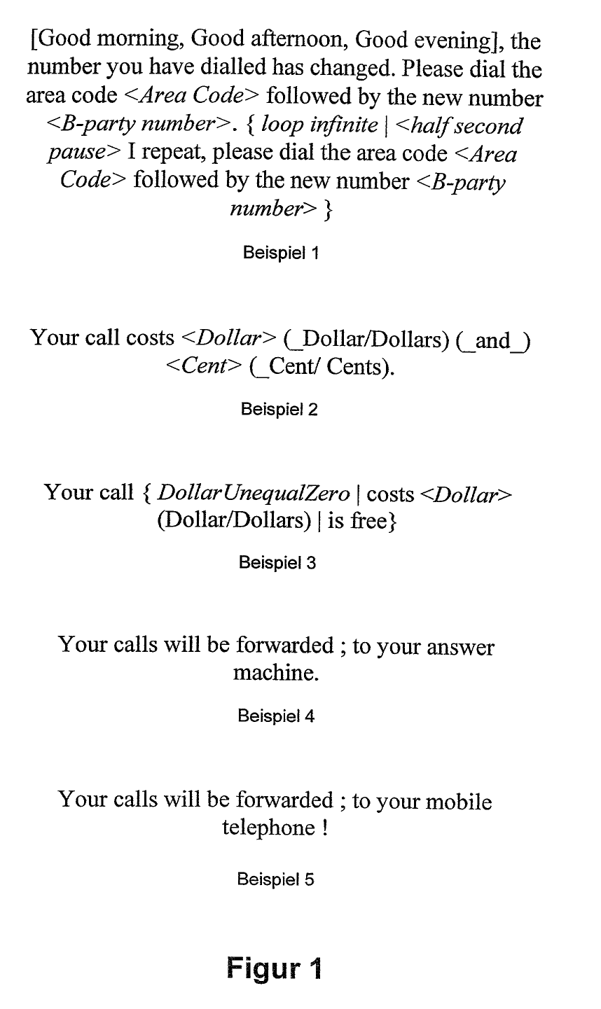

FIG. 1 illustrates a series of examples of announcement types from which a selection is made by means of the process according to the invention in a spoken announcement module according to the invention and which are varied and output in accordance with the current parameters;

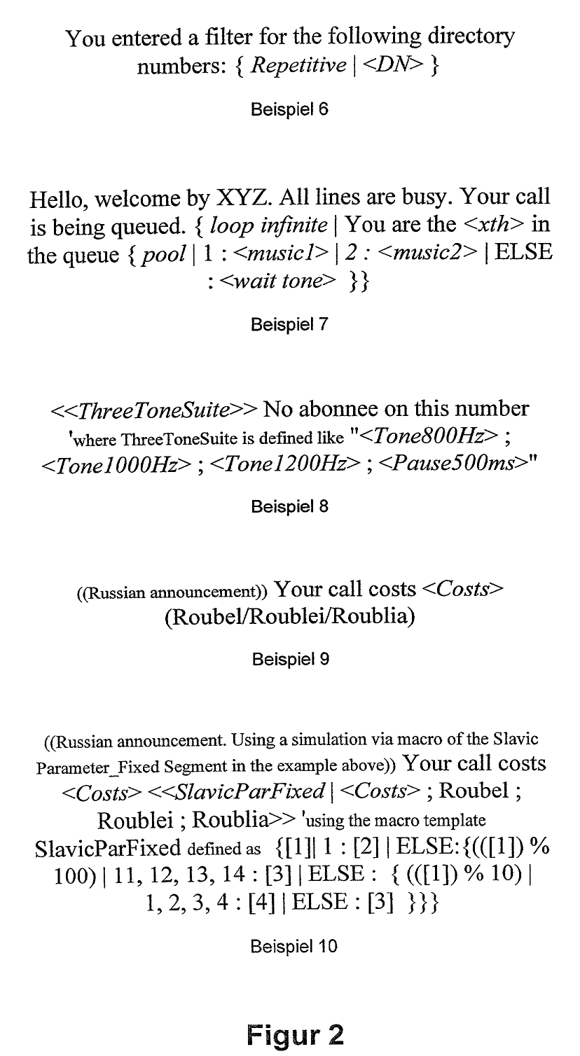

FIG. 2 illustrates another series of examples as in FIG. 1;

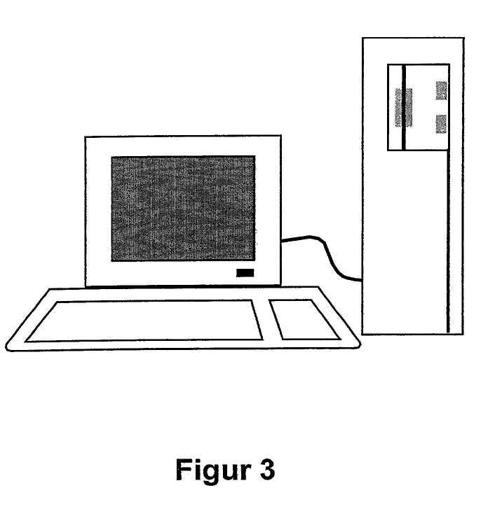

FIG. 3 is a more symbolic representation of an exemplary embodiment of a PC with a spoken announcement module according to the invention.

Firstly the manner in which the invention can express itself will be briefly explained in the form of Example 1 as illustrated in FIG. 1.

This will however be preceded by a few words concerning language. (This also constitutes a note of advice to the translators who will later have to translate the English version into other languages). On the one hand the invention relates to a spoken announcement, for which reason it is concerned with language, and on the other hand the invention expresses itself in the form of a programming language. Thus language can be considered not only as a means of describing the invention, but also as the content and mode of expression of the invention.

Example 1 of FIG. 1, as well as most other examples, is based on the assumption that the speech output is to take place in English. The speech elements to be output, e.g. “Good morning, Good afternoon, Good evening” are therefore, as a form of expression of the invention, represented in English, although the invention is described here in German. The same applies to the program code as such, for example the variable names, such as “<Area Code>”, or instructions such as “loop infinite”. The same also applies to comments such as “where ThreeToneSuite is defined like” in Example 8 of FIG. 2 since, in accordance with the invention, non-executable “instructions” are also permissable as comments and these are then generally likewise written in English.

An exception is illustrated in Examples 9 and 10 of FIG. 2 and will be discussed in association with the description of these examples.

Thus that which is stated in German in the original German-language version constitutes the description of the invention, while that which is stated in English constitutes the content or form of expression of the invention. (This differentiation can then also be made in further translations). However, even in the English-language version, at least the text of the examples in the drawing and the references in the description to the examples of the drawing will be clearly recognisable as constituting the content or form of expression of the invention.

As in the case of inventions in other technological fields, country-specific adaptations are not of course thereby ruled out. In this case however, such country-specific adaptations would primarily consist of replacing the syntax elements by those based on the language of the relevant country.

Now to return to Example 1 of FIG. 1:

Firstly, with “[Good morning, Good afternoon, Good evening]”, a greeting corresponding to the time of day is selected and output, the selection taking place automatically. Then a new call number, including the required prefix, is announced in that two fixed record components, “the number you have dialled has changed. Please dial the area code” and “followed by the new number”, alternate with two variables “<Area Code>” and “<B-party number>”. In an endless loop “{loop infinite|<half second pause> I repeat, please dial the area code <Area Code> followed by the new number <B-party number>}”, the output, with the addition of a pause “<half second pause>” and of the reference to the repetition “I repeat”, is then repeated until the output is terminated by the addressee. For simplicity here the pause is output as a variable of predeterminable length but with no speech content.

In this example the syntax elements “greeting”, “fixed record components”, “variables” and “loops” have been used and presented by way of example. Before further examples are discussed, the syntax of this programming language will be briefly summarised, but not necessarily in full; a supplementation, modification or reduction are not to be ruled out.

Compared to a conventional programming language such as C, C++ or Pascal, it is clear that the programming language in which the process according to the invention is expressed requires no explicit commands. Rather it consists of references and separators. The references here represent the links to where the required information is located, while the separators define the context in which the references are made. The references, for example a text sequence, are of significance only in association with a context. The context, and thus the significance of the reference, can be changed by the use of a specific separator, for example “<” or “>”.

In practice, in accordance with the specific context an automatic translator will use a special table to translate the references in the form of natural language into an application-specific format which can then be read by the spoken announcement module according to the invention. To render the input more flexible and legible, this programming language also supports punctuation symbols. These are invariable symbols which are of no significance in the translation. They can be added or removed by the user to improve the appearance and legibility but have no technical effect.

In this way a spoken announcement module can be programmed very simply and after only brief familiarisation; the result, i.e. the program, can be used directly for the documentation and can also be translated by automatic translation into a lower application-specific language.

An announcement is a collection of fixed elements (“elements”) such as “no terminal under this number” and complex segments (“Complex_Segments”) for which runtime-specific statements, such as parameters, are also required in a concrete application. For example in the case of the announcement “The call costs <x> DM”, the “<x>” stands for a parameter which is not known until the announcement actually takes place. Here runtime is a term for the instant at which the compilation into a spoken announcement currently to be output actually takes place.

In the following ( . . . ) means an additional option (“option”), [ . . . v . . . v . . . ] a choice (“choice”) and { . . . } an extension (“extension”).

Thus an announcement has the following construction:

Announcement=(prefix), Segment_List, (Suffix) where:

| | |
|---|---|
| Prefix, Suffix | = [Element_List] |
| Segment_List | = Segment {, Segment} |
| Element_List | = Element {, “;”, Element} |
| Parameter_List | = Parameter {, “;”, Parameter}, where a |
| | parameter can be an element, a segment, |
| | a number or a variable, for example a |
| | runtime variable. |
| Element | = [Text description v “arbitrary_text”] |
| Segment | = [Element_List v Complex_Element v |

Parameter_Fixed v Block_Segment]

| | |
|---|---|
| | (, Punctuation sign) (, Flush sign “\”) |
| Complex_Element | = “<”, Complex_Reference, “>” |
| Block_Segment | = “{”, Block_Reference, “\|”, |
| | Segment_List ({, “\|”, |
| | Segment_List}), “}” |
| IfThenElse_Segment | = “{”,Block Reference or Expression, |

“|”, Segment_List_If (, “|”, Segment_List_Else), “}”

| | |
|---|---|
| Branch_Segment | = “{”, Block_Reference or Expression, |

“|”, Number_List, “:”, Segment_List ({, “|”, Number_List,
“:”, Segment_List}), (, “|”, “ELSE:” Segment_List), “}”.

| | |
|---|---|
| | At the runtime “Block_Reference” or |
| | “Expression” is determined and a jump |
| | takes place to the branch bearing the |
| | number defined in the “Number_List”. |
| | Otherwise a jump takes place to the |
| | branch defined under ELSE, if one such |
| | is present. |
| Parameter_Fixed | = “(”, (“_”, Element_Singular (, [“/” v |
| | “\”, Element_Plural1 (, [“/” v “\”], |
| | Element_Plural2)), (“_”), “)”. The “_” |
| | symbol stands for the suppression of |
| | the preceding and/or following |
| | parameter, while the “/” symbol stands |
| | for identity with the preceding or |
| | following parameter. In Slavic |
| | languages a second plural, Plural2, |
| | must be defined. |
| Macro | = “<<”, Macro_Reference ({, “\|”, |
| | Parameter_List}), “>>” |
| Macro_Parameter | = “[”, Parameter_Number, “]”. Stands |

for any detail of the macro-definition itself.

An expression, “Expression”, is an Algebraic term which is evaluated at the runtime and comprises known operators, such as for example +, −, /, *, % (modulo), ! (not), and, or, xor, =, <>, <=, >=, <, > or any other system-specific operators. For example “(Month=2) and (day>15)” is a valid expression.

A “Block_Reference” is a reference to a detail such as:

1. a loop instruction such as “loop 5 times” or “loop infinite” (only in the case of the output of words): ({loop| . . . }),

2. an instruction for a duration such as “10 seconds” (only in the case of the output of words): ({duration| . . . }),

3. an instruction to repeat, such as “loop as long as the parameter buffer is not empty”: ({repetitive| . . . }) or

4. an expression to be evaluated at the runtime, such as “Euro=0 and Cent<>0”, which is used together with the IfThenElse_Segment ({Euro=0 and Cent<>0|(then)|else)} or the Branch Segment ({Key pressed|1,2: . . . |5: . . . ELSE: . . . })

A Complex_Reference is a reference to a complex detail such as:

1. a parameter value and the associated rule in accordance with which it is generated,

2. a (large) “Element_List” or

3. any complex detail occurring as a feature.

A “Macro_Reference” is a reference to a macro which again is a collection of elements and segments, and any announcement in which an element or a part thereof can be symbolically replaced by a parameter. A macro is resolved upon compilation, each Macro_Parameter being replaced by its value taken from the parameter list “Parameter_List”. A macro operates in exactly the same way as in every known higher programming language, for example C++.

A “Parameter_Number” is a cardinal number representing the n-th parameter of the “Parameter_List”.

A “punctuation sign” is any character not belonging to the character set “/;<>{}( )[ ]|. It can be separately stored and need not be part of an element (an element can be a component of different announcements). This character is of no significance for the spoken announcement.

The “Flush sign” is to be treated like a character for carriage return or a new line. It is only of significance if a text output takes place for example in addition to the speech output. The so-called “backslash”, “\”, a character not used for other purposes, can be used for example as “Flush sign”.

Before the technical implementation is discussed, the further examples shown in FIGS. 1 and 2 will also be briefly discussed.

Example 2 according to FIG. 1 shows the programming for the announcement of a price, assuming that the call is or was not completely free of charge. The syntax of the “Parameter_Fixed” is used here. Firstly a fixed announcement component “Your call costs” takes place, followed by a statement in dollars and cents. The current values therefore, <Dollar> and <Cent> are inserted when this announcement is called. The associated units, Dollar, Dollars, Cent or Cents, are in each case subsequently added, the singular form Dollar or Cent, or the plural form, Dollars or Cents, of the unit additionally being output depending upon the value. If one of the two values is zero, this is not output and the associated unit is also suppressed. The linking “and” is suppressed both when the preceding value, <Dollar>, is zero and when the following value, <Cent>, is zero.

Example 3 in FIG. 1 shows an announcement similar to that in Example 2 but rounded up or down only to whole Dollars. Here a simple suppression of data is no longer sufficient. Therefore here the Branch_Segment DollarUnequalZero differentiates between the situation in which there is something to pay, “costs <Dollar> (Dollar/Dollars)” and that in which there is nothing at all to pay, “is free”. The suppression of the unit is unnecessary here since this branch is anyhow only activated when the value is unequal to zero.

In the event that on the one hand precise billing is to be provided, but on the other hand cost-free calls are also possible, the two examples can of course be combined, in which case however the Branch_Segment DollarUnequalZero must be differently defined or replaced by a different Branch_Segment, for example PriceUnequalZero. The instructions DollarUnequalzero and PriceUnequalZero must be defined elsewhere, for example as function or subprogram, as is customary in programming languages. Instead of the Branch_Segment DollarUnequalZero, the associated equation (Dollar·Zero) could also be input directly. In such simple cases it may not be worthwhile providing and calling a separate function. The extent to which this would also apply to a modified Branch_Segment, for example PriceUnequalZero, would depend upon the inner construction which has not been defined in detail here.

The following three examples, Example 4 and Example 5 from FIG. 1 and Example 6 from FIG. 2, show examples for possible confirmations of changes to a user profile made by the user. These three examples each illustrate a first announcement section in which the type of change made is confirmed, “Your calls will be forwarded” or “You entered a filter for the following directory numbers”, and a second section which confirms the content of the change made i.e., in the case of call diversion or forwarding, the relevant destination: “to your mobile telephone!” or “to your answer machine”, and when a series of call numbers for a call number filter are input, all the input call numbers are output for checking by means of the Block_Reference {Repetitive|<DN>}.

An announcement of more complex construction will be described with reference to Example 7 in FIG. 2. This shows an announcement for a subscriber waiting in a queue. Firstly a greeting is given: “Hello, welcome by XYZ. All lines are busy. Your call is being queued.”, whereupon the fact that one is currently in a queue is repeatedly pointed out by a Block_Reference {loop infinite|. . . }: “You are the <xth> in the queue”. Additionally, the number occupied in this queue is stated as variable “<xth>”. From the countdown speed it is possible to estimate how much longer one must wait. To make it clearer that the end of the queue is approaching, a modification of the announcement towards the end is provided for by a further Block_Reference, {pool|1: <music1>|2: <music2>|ELSE: <wait tone>). Each time the endless loop “loop infinite” is run, an acoustic signal is output which is selected from a pool “pool” and which normally, “ELSE”, is a waiting signal “<wait tone>” and which towards the end of the queue is replaced by two different music sequences, firstly “<music2>” and then “<music1>”. The waiting signal could consist of a predefined sequence of tones, as in the following example.

Example 8 in FIG. 2 shows a simple output for the situation in which no subscriber terminal exists under the dialled call number. The output is firstly initiated by the execution of a macro-command “<<ThreeToneSuite>>” and then completed by a simple output “No abonnee on this number”. This example also includes an option of using comments. As in any programming language, here too the insertion of comments can be provided. An option provided in many programming languages consists of disregarding everything that follows a quotation mark “'”; in this way the comment “where ThreetoneSuite is defined like “<Tone800 Hz>; <Tone1000 Hz>; <Tone1200 Hz>; <Pause500 ms>” is added in order to briefly explain the content of this macro. The macro itself must of course be defined elsewhere.

The two last examples, Example 9 and Example 10 from FIG. 2, basically illustrate the same output, namely the statement of a cost amount in a Slavic language, namely Russian. Slavic languages have two different plural formations which must be taken into account in the output. (Strictly speaking, here the genitive singular is used as second plural formation).

To illustrate this in a text not in a Slavic language, the currency data, “Roubel/Roublei/Roublia” concerned here are given in Russian but transliterated into English. The remainder, both the announcements themselves, “Your call costs”, and also comments ((Russian announcement)), and other program elements <Costs>, are represented in English. Here the use of double round brackets is considered as another means of inserting a comment. A comment of this kind is to be simply skipped whereas when a quotation mark “'” is used to symbolise a comment, everything that follows is to be disregarded.

Example 10 in FIG. 2 shows both types of comments. In Example 9 it is assumed that when the variable <Costs>is called, the macro for the selection of the correct currency unit is also automatically called, while in Example 10 this takes place explicitly by the macro instruction <<SlavicParFixed|<Costs>; Roubel; Roublei; Roublia>>. In this Example 10, more detailed comments are also added, for example the definition of the macro is added as a comment.

Only when the value of the variable <Costs>is “1” is the singular form “Roubel” output as currency unit. If, in the case of a value unequal to “1”, the value of the variable <Costs>ends with 1, 2, 3 or 4 but not 11, 12, 13 or 14, the form “Roublia” is used, while in all other cases the form “Roublei” is used.

The different announcements are not of course stored as shown in FIGS. 1 and 2. In particular, although the graphic representation used here, in some cases also with different texts, provides for clearer understanding, it cannot be stored in this form. However visualisation in precisely this form is possible using an appropriately designed editor. The actual storage takes place in the form of tables however.

Thus for example a first table is provided for the storage of announcements as such. This table has a first column containing unequivocal identifications, a second column containing the designations of the relevant announcements, a third column containing the language in each case being used, fundamentally a comment, and a fourth column containing the definitions of the announcements. A column with comments can also be provided. However, instead it is also possible to provide a further table which contains only comments and which is linked via the unequivocal identifications to rows of this table or also to rows of other tables.

A second table contains the “Block_Segments”, the columns for unequivocal identifications, for the designations, the “Block_References” and for the definitions of these “Block_Segments. Further definitions are stored in further tables.

Finally, the more external form of the realisation will also be briefly discussed. For this purpose FIG. 3 illustrates a PC known per se, which by suitable equipment is provided as a spoken announcement module according to the invention with a program module according to the invention. The screen shown in this example serving as output means and the keyboard shown here serving as input means are not essential in the basic equipment. The spoken announcement module then forms part of a so-called server, i.e. a computer, which only operates in association with other computers and undertakes specific tasks therefor.

This server can consist for example of a charge computer of the operator of a telecommunications network to which charge data are constantly transmitted and which is not only to be used for the monthly charge billing but at the end of each call outputs the incurred costs in spoken form. These costs can be determined from the data content of a data record containing the connection data of this call. Optionally the language in which the output is to take place then is also derived from a second data record containing specific information about the terminal which has incurred these costs. Examples in this respect are Examples 2, 3, 9 and 10 from FIGS. 1 and 2.

However this “server” can also consist of a switching processor which in a so-called call centre distributes the incoming calls between the individual operators' stations. Here it must be possible for the spoken announcement module to access the data records of the calls waiting in the wait loop in order to determine the current position of each such call and, as shown in Example 7 of FIG. 2, to be able to output this information in spoken form.

In both cases, and indeed in all other cases, in addition to the indicated data access means, speech output means are also required, with which the spoken announcements formed by the spoken announcement module can also actually be output. The conversion of each assembled spoken announcement into spoken language and the output thereof via a suitable (analogue or digital) terminal to a telecommunications network must take place in some manner known per se.

The data record containing the above mentioned specific information about a terminal is often also referred to as “user profile”. It can now be permitted for a user to himself influence at least parts of this data record by some method of remote input and for the result of this remote input to be subsequently output again in spoken form for checking and confirmation purposes. Relevant examples are Examples 4, 5 and 6 of FIGS. 1 and 2.

Examples 1 and 8 of FIGS. 1 and 2 illustrate two possible announcements of a switching processor in the situation in which a subscriber cannot be reached under the dialled call number via this switching processor. In this case either a new subscriber number, if known, is output (Example 1) or it is announced that no entry exists under this subscriber number (Example 8). The enquiry in the subscriber database of this switching processor then contains a data record which, under the previous, now dialled call number, contains a reference to the new call number, or the data access of the data access means is responded to by an error message, as a special form of a data record, stating that no entry exists.

Frequently computers of this kind, which can be equipped with spoken announcement modules according to the invention, are used simultaneously to maintain at least a part of the data which forms the basis of the spoken announcements. In all these situations, for example in hotels or hospitals, the data undergo continuous changes, for which purpose input- and output means, as also shown in FIG. 3, are essentially needed. In such cases the organisational procedures also change frequently, which again necessitates an adaptation of the spoken announcements. However in accordance with the present invention, the programming of new announcements or the modification of existing announcements can be performed relatively easily, even by personnel with little training. Therefore in such cases it is advantageous for the spoken announcement module also to be equipped with suitable editing means. The editors anyhow provided in virtually all computers can generally be used for this purpose, or also a recording program. In this case the computer being used should additionally comprise input- and output means (microphone, loudspeaker) for spoken speech for the recording of texts and the testing of programmable announcements.

The program module according to the invention for use in a spoken announcement module according to the invention for the execution of the process according to the invention for outputting a spoken announcement is of standard construction. It falls within the scope of standard programming tasks to divide a program into segments (subroutines, procedures), where individual segments are intended more for controlling the program run and others for the execution of individual activities, to link this program with drivers for the data access and speech output and to fill it with the above described inventive contents.

1. A process for outputting a spoken announcement, the content of which is a function of the data content of at least one data record, characterised in that an announcement type is selected by means of a first program segment on the basis of the data content, that a second program segment for the program-controlled output is made available, which second program segment is suitable for the selected announcement type, that the parameters required for the second program segment which has been made available are determined, and that the spoken announcement corresponding to the selected announcement type taking into account the determined parameters is output.

2. A spoken announcement module for outputting a spoken announcement, the content of which is a function of the data content of at least one data record, characterised in that the spoken announcement module comprises a program control, that a first program segment is provided by means of which an announcement type can be selected on the basis of the data content, that a second program segment from a plurality of second program segments is assigned to each announcement type, that data access means are provided for determining from the at least one data record the parameters required for a selected second program segment, and that speech output means are provided for outputting the spoken announcement corresponding to the selected announcement type taking into account the determined parameters.

3. A program module for use in a spoken announcement module for outputting a spoken announcement, the content of which is a function of the data content of at least one data record, characterised in that the program module comprises a program control segment, a first program segment and a plurality of second program segments, that the program control segment is designed to control the access to data access means and speech output means and to control the calling of the first program segment and of a program segment from the plurality of second program segments, that the first program segment is designed such that it can be used for the selection of an announcement type and of a second program segment, assigned to this announcement type, from the plurality of second program segments, and that each of the second program segments from the plurality of second program segments is designed such that it forms a current spoken announcement with the assistance of the required parameters which are determined by means of the program control segment and the data access means from the at least one data record, and that it causes this spoken announcement to be output by means of the program control segment and the speech output means.

4. A spoken announcement module according to claim 2, characterised in that editing means are provided, by means of which existing announcement types with associated second program segments can be changed or erased, or new announcement types with associated second program segments can be generated, and that input- and output means are provided via which it is possible to communicate with the editing means.
